(19) United States
(12) Patent Application Publication
(10) Pub. No.: US 2006/0196317 A1
(43) Pub. Date: Sep. 7, 2006

(54) Adjustable ratchet wrench

(75) Inventor: Terry Kinskey, Alpharetta, GA (US)

Correspondence Address: STITES & HARBISON, PLLC, 400 W MARKET ST, SUITE 1800, LOUISVILLE, KY, 40202-3352, US

(73) Assignee: Infinity Consulting Group, LLC

(21) Appl. No.: 11/070,203

(22) Filed: Mar. 3, 2005

(51) Int. Cl. B25B 13/46

(52) U.S. Cl. 81/63.1

(57) ABSTRACT

A ratchet device comprises a ratchet body and an adjustable dimension opening member to accommodate varying size bolt heads or nuts. The adjustable dimension opening member is rotationally connected to the ratchet body. In one specific form, the adjustable dimension opening member comprises two opposing arms, with at least one of the arms being translatable toward the other arm thereby adjusting an opening between the two arms. In an alternative form, the adjustable dimension opening member is selectable between two configurations, with one configuration permitting exclusive clockwise rotation relative to the racket body and a second configuration permitting exclusive counterclockwise rotation relative to the racket body.

### FIELD OF THE INVENTION

The present invention relates to a tool for removing bolts and nuts, and in particular, a ratcheting tool for bolt or nut removal, which is adjustable to accommodate varying sizes of bolt heads and nuts.

### BACKGROUND OF THE INVENTION

Various tools are used for tightening or loosening bolts and nuts. Two such tools are an open-ended wrench and a close-ended wrench. Both types of wrenches have a specific opening to accommodate corresponding size bolt heads or nuts. In order to accommodate different sizes of bolt heads or nuts, one would need different wrenches having different corresponding opening sizes.

One advancement over individual open-ended or closed-ended wrenches is a crescent wrench having an adjustable opening to accommodate varying sizes of bolts or nuts, depending on the adjustment of the wrench opening.

An alternative wrench design to open-ended and closed-ended crescent wrenches is a socket wrench, which includes a ratchet and a socket end for accepting a plurality of different size interchangeable sockets. Each socket is specifically dimensioned to accommodate a specific size bolt head or nut. An advantage of a socket wrench is its ratcheting feature which allows selective movement in either a clockwise or counterclockwise direction relative to the handle of the wrench thereby providing for what is know in the art as a “ratcheting action” to allow one to quickly loosen or tighten a bolt or nut.

A disadvantage of conventional adjustable crescent wrenches is that they do not provide a ratcheting action. Therefore, these wrenches do not allow one to quickly and easily tighten or loosen a bolt or nut by rotating the wrench over a desired arc or degree of rotation around the bolt or nut. A disadvantage with conventional socket wrenches is that, since the sockets are not adjustable, one needs a specific socket for each different size bolt or nut one wishes to adjust. Since bolts and nuts come in variety of different sizes including both English and metric units, one needs to have numerous sockets at his or her disposal in order to accommodate these different sizes of bolts and nuts.

Accordingly, there is a need in the art for an improved tool which provides fast and easy bolt and nut removal using an adjustable tool.

### SUMMARY OF THE INVENTION

The present invention relates to an adjustable tool such as a ratchet device having a ratchet body and an adjustable dimension opening member which accommodates varying sizes of bolt heads or nuts. The adjustable dimension opening member is rotatably connected to the ratchet body. Advantageously, the adjustable dimension opening member is selectively rotatable either clockwise or counterclockwise relative to the body. For example, the adjustable dimension opening member can be selectable between one of two configurations in which one configuration permits exclusive clockwise rotation, and a second configuration permits exclusive counterclockwise rotation, of the adjustable dimension opening member relative to the body.

In one specific form of the adjustable dimension opening member, the member includes two opposing fork arms in which at least one of the fork arms is translatable towards the other fork arm thereby adjusting an opening between the two fork arms. Advantageously, the adjustable opening between the two fork arms forms or accommodates varying sizes of bolt heads and nuts. In one further form, a thumb wheel is rotatable to move the fork arms together or away from each other.

In yet another further form, each of the adjustable fork arms has a V-shaped cross-section portion for accommodating varying bolt and nut surfaces. In still another form, each fork arm has a longitudinal channel formed through respective vertices of each V-shaped cross-section portion for accommodating varying bolt and nut surfaces.

In another form of the present invention, a tool for tightening or loosening bolts or nuts includes an adjustable dimension opening member having two opposing fork arms. At least one of the fork arms is translatable towards the other fork arm thereby adjusting an opening between the two fork arms. Each fork arm has a V-shaped cross-section portion.

### BRIEF DESCRIPTION OF THE DRAWINGS

The invention will now be described in more detail with reference to the accompanying drawing, in which:

FIG. 1 is a plan view of an adjustable ratchet in accordance with the present invention;

FIG. 2 is a perspective view of the ratchet of FIG. 1;

FIG. 3 is a sectional view of the ratchet of FIG. 1 taken along line 3-3;

FIG. 4 is a sectional view of an adjustable dimension opening member of the adjustable ratchet in FIG. 3 taken along line 4-4;

FIG. 5 is an exploded view of the ratchet of the view in FIG. 2; and

FIG. 6 is an exploded view of a ratchet in accordance with another embodiment of the present invention.

### DETAILED DESCRIPTION OF THE INVENTION

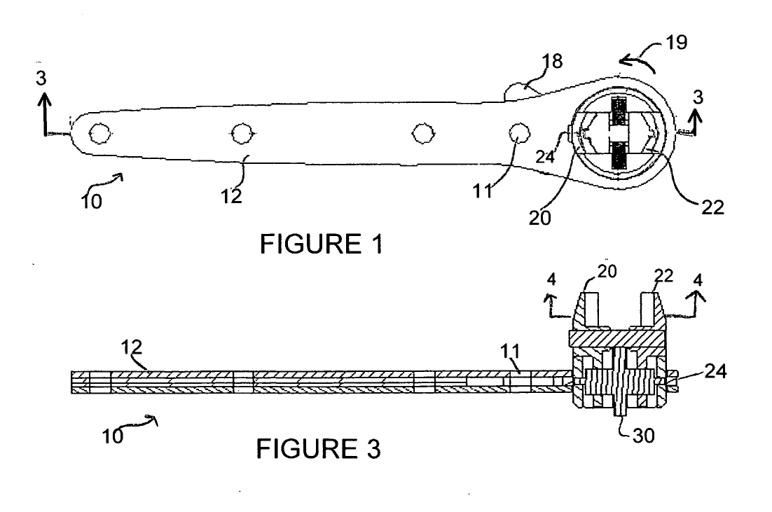

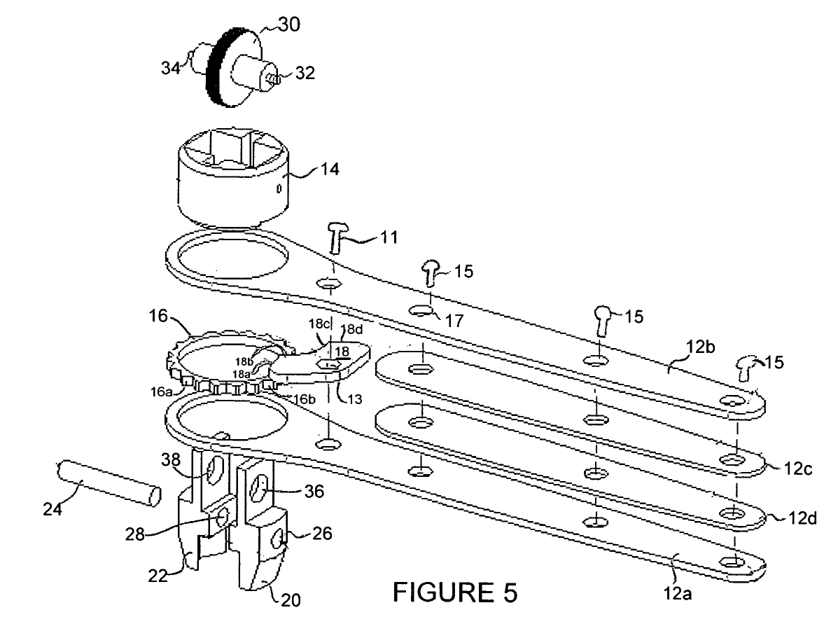

Referring to FIGS. 1-5, ratchet 10 includes a handle 12 which forms the body of the ratchet and an adjustable opening member in the form of two opposing adjustable fork arms 20, 22. The fork arms 20, 22 are disposed in housing 14 which is selectively rotatable either clockwise or counterclockwise relative to the handle 12.

Handle 12 is formed from two exterior handle members 12a, 12b and two intermediate handle members, 12c, 12d. A plurality of rivets 15 are disposed in a respective one of a plurality of holes 17 to form the handle 12.

Handle 12 can be modified to include a tool bit tray for accommodating various tool bits such as screw driver bits or hex bits. Further, the handle 12 can be modified to include a tool bit holder extending in the longitudinal direction of the handle, at the end of the handle opposite the fork arms 20,22. The tool bit holder accommodates various tool bits including those which can be disposed in the tool bit tray.

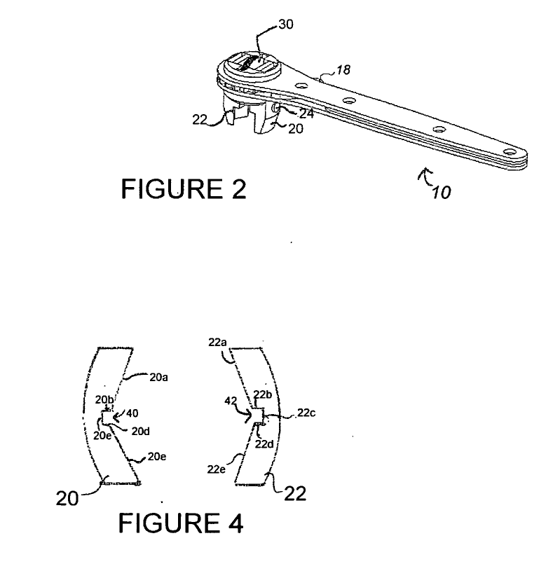

Cog 16 is affixed to housing 14. Rocker 18 is pivotally disposed between exterior handle member 12a and exterior handle member 12b about rivet 11 which pass through bore 13. Rocker 18 is selectable between one of two positions. In a first position, as depicted in FIGS. 1 and 2, rocker surfaces 18a, 18b abut one of a plurality of cog surfaces 16a, 16b respectively. As a result of the abutting surfaces, housing 14 can rotate exclusively counterclockwise as depicted by arrow 19 but not clockwise i.e., a direction opposite of arrow 19. In this configuration, since the housing 14, which holds the adjustable member, is fixed with respect to the handle 12, one can use the ratchet 10 to tighten a bolt or nut as will be discussed in further detail below.

In an alternate configuration (not shown), rocker 18 is pivoted along rivet 11 such that rocker surfaces 18c and 18d abut cog surfaces 16a, 16b, respectively. In this configuration, housing 14 is permitted to turn clockwise in a direction opposite to that of arrow 19. In this configuration, the ratchet 10 can be used to loosen a bolt or nut.

Axel 24 is disposed in axel bore 26 and fixed to fork 20, on one end, and slidingly disposed through axel bore 28 of fork arm 22, on the other end. Thumb screw 30 includes threads 32, 34 which are complementary to threaded bores 36, 38 of fork arms 20, 22, respectively. Rotation of thumb wheel 30 causes fork arms 20, 22 to move towards or away from each other as fork arm 22 slides along axel 24. As a result of the rotation of thumb wheel 30, the fork arms 20, 22 form a variably sized dimension opening to accommodate varying sizes of bolt heads and nuts.

Referring to FIGS. 3 and 4, fork arms 20, 22 have a broad V-shaped cross-section with a longitudinal channel 40, 42 formed through respective vertices of each V-shaped cross-section portion of fork arms 20, 22, respectively. Fork arm surfaces 20a-20e and 22a-22e are adapted to make contact with various surfaces of a bolt head or nut to be adjusted. For example, an apex or corner of a bolt head or nut may be located within the longitudinal channel 40, 42 with other bolt head/nut surfaces making contact with selected portions of surfaces 20a, 20e; and 22a, 22e. Alternatively, if the bolt head or nut is partially stripped, surfaces 20b, 20c, 20e or 22b, 22c, 22d may make physical contact with the bolt head or nut. Rotation of thumb screw 30, as described above, permits fine adjustment of the fork arms 20, 22 so that the surfaces 20a-20e and 22a-22e make a sufficiently tight fit around the head of a bolt or nut to permit its tightening or loosening.

In an alternative embodiment to the one depicted, fork arms 20, 22 may not include a longitudinal channel 40,42 and instead, each fork arm forms a true V-shaped vertex.

As noted above, fork arms 20, 22, include surfaces 20a, 20e and 22a, 22e, respectively, which make contact with a non-striped bolt head or nut. Consequently, the ratchet 10 would be referred to as a four point wrench, with each fork arms 20, 22 making contact with two surfaces of a bolt head or nut for a total of four points of contact. In alternative embodiments, the fork arms 20, 22 can be modified to have additional surfaces which make contact with a bolt head or nut to be adjusted. For example, the fork arms 20, 22 may each include one or two additional surfaces which make contact with a bolt head or nut thereby forming a six and an eight point wrench, respectively. Alternatively, the fork arms 20,22 together may have any number of points as desired including twelve or sixteen points.

In yet an alternative embodiment, the length of the fork arms 20, 22 can be lengthened to accommodate the adjustment of bolts and nut which may not be accessible with a shorter fork arm length.

In use, ratchet 10 is adjustable to accommodate varying sizes of bolt heads or nuts to be tightened or loosened. A user adjusts the rocker 18 to select between a tightening configuration or a loosening configuration of the ratchet 10. Thumb wheel 30 is rotated clockwise or counterclockwise until the fork arms 22 form a desired opening size to accommodate a bolt head or nut to be tightened or loosened. Subsequently, ratchet 10 is used like a conventional socket wrench to tighten or loosen a bolt or nut.

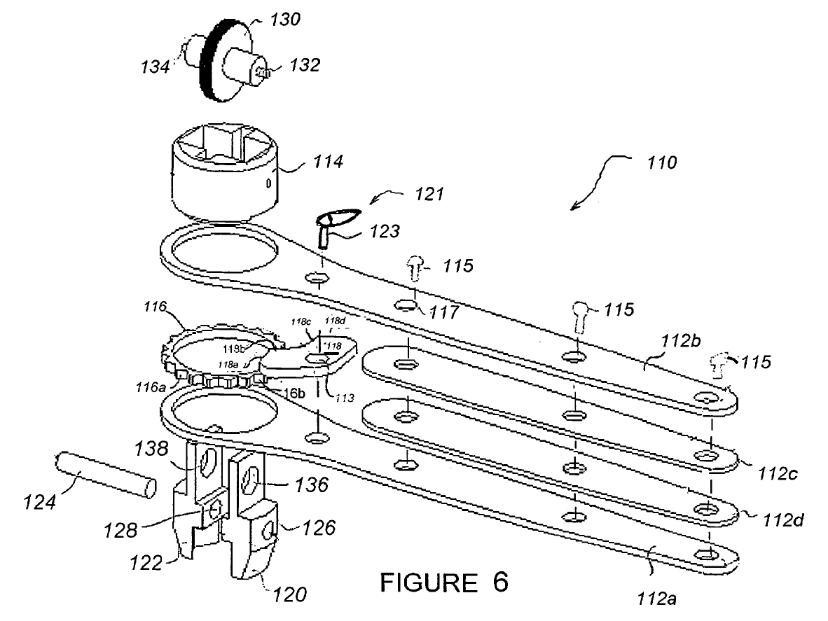

Referring now to FIG. 6, where like elements are numbered the same as in the embodiment of FIGS. 1-5 but increased by 100, in an alternative embodiment, ratchet 110 includes a lever 121 with stem 123. Step 123 passes through bore 113 and engages the hexagonal surfaces thereof. Rotating lever 121 pivots rocker 118 to thereby select between a clockwise or counter-clockwise rotation of the fork arms 20, 22 relative to the handle 120.

It will now be readily apparent to one of ordinary skill in the art that the present adjustable ratchet 10 offers advantages and features not found in prior tools. For example, the present ratchet 10 provides an adjustable dimension opening member which accommodates varying sizes of bolt heads and nuts. Further, the present ratchet 10 provides quick and easy ratcheting action to expedite the tightening or loosening of a bolt or nut via its cog and rocker elements.

Further, the unique and novel design of the fork arms, which includes a V-shaped cross-section and longitudinal channel, accommodates varying bolt and nut surfaces. As a result, the present ratchet is less likely to strip a bolt head or nut and is able to accommodate irregularly shaped bolt heads and nut such as ones that have become previously stripped or worn.

In addition, the present adjustable ratchet wretch can be composed of different appropriate materials including various steel and alloy materials. Further, the wretches in accordance with the present invention can have various body sizes and handle lengths depending on the desired use and preference.

Although the invention has been described in considerable detail with respect to preferred embodiments, it will be apparent that the invention is capable of numerous modifications and variations, apparent to those skilled in the art, without departing from the spirit and scope of the invention.

What is claimed is:

1. A ratchet device comprising:
a ratchet body; and
an adjustable dimension opening member to accommodate varying size bolt heads or nuts, said adjustable dimension opening member rotationally connected to said ratchet body.

2. The ratchet device of claim 1, wherein said adjustable dimension opening member is selectively rotatable clockwise or counterclockwise, relative to said body.

3. The ratchet device of claim 1, wherein said adjustable dimension opening member is selectable between two configurations, one said configuration permitting exclusive clockwise rotation relative to said body and a second said configuration permitting exclusive counterclockwise rotation relative to said body.

4. The ratchet device of claim 1, wherein said adjustable dimension opening member comprises two opposing arms, at least one of said arms translatable toward said other arm thereby adjusting an opening between said two arms.

5. The ratchet device of claim 4, wherein both opposing arms are translatable toward each other.

6. The ratchet device of claim 4 wherein each said arm has a V-shaped cross-section portion.

7. The ratchet device of claim 6, wherein each said arm has a longitudinal channel formed through respective vertices of each said V-shaped cross-section portion.

8. The ratchet device of claim 6, wherein said V-shaped cross-section portion comprises surfaces which abut a bolt head or nut to be adjusted.

9. The ratchet device of claim 1, wherein said adjustable dimension opening member accommodates varying size bolt heads or nuts without interchangeable sockets.

10. A tool for tightening or loosing a bolt or nut, said tool comprising:
an adjustable dimension opening member comprising two opposing arms, at least one of said arms translatable toward said other arm thereby adjusting an opening between said two arms, each said arm having a V-shaped cross-section portion.

11. The tool of claim 10, wherein each said arm has a longitudinal channel formed through respective vertices of each said V-shaped cross-section portion.

12. The tool of claim 10, wherein said V-shaped cross-section portion comprises surfaces which abut a bolt head or nut to be adjusted.
